(19) United States
(12) Patent Application Publication
(10) Pub. No.: US 2008/0202663 A1
(43) Pub. Date: Aug. 28, 2008

(54) SURFACE PROTECTION FILM WITH LOW UNWIND FORCE

(75) Inventors: NICOLE BEHRENS, HAMBURG (DE); NICOLAI BOHM, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, Hamburg (DE)

(21) Appl. No.: 12/018,814

(22) Filed: Jan. 24, 2008

(30) Foreign Application Priority Data
Feb. 27, 2007 (DE) 10 2007 009 753.2
May 11, 2007 (DE) 10 2007 022 727.4

(51) Int. Cl. B32B 7/12; B29C 65/48; B32B 27/00; B29C 47/06

(52) U.S. Cl. 156/60; 428/354; 428/332; 428/353; 428/355 R; 264/173.16

(57) ABSTRACT

The invention relates to a self-adhesive protective film composed of a backing to one side of which an adhesive is applied, characterized in that the backing has at least two layers: a first layer, facing the adhesive, comprising an unoriented film which comprises at least one propylene block copolymer with an amount of 10% to 95% (w/w), and a second layer, facing away from the adhesive, comprising a film which contains at least 75% (w/w), preferably at least 80% (w/w), of a low-density polyethylene.

The invention relates to a weathering-stable self-adhesive protective film with high adhesion for protecting surfaces such as glass, ceramic, stainless steel, polycarbonate glass or acrylic glass, more particularly painted surfaces, while at the same time having a low unwind force in roll form. The protective films of the invention are more particularly suited to the protection of the fresh finish of vehicles such as cars and for protecting freshly painted vehicle parts from soiling and damage during assembly, transit and storage.

### BACKGROUND OF THE INVENTION

EP 0 592 913 A1 describes a surface protection film for the transit of cars that consists of an EVAc copolymer having a vinyl acetate content of 33%. With this protective film, the application of an additional adhesive layer does not take place. A film of this kind has a simple structure, but exhibits distinct disadvantages in use. Owing to the high crystalline fraction, the bond strength is very low; this deficiency is said to be eliminated by heating during application. Additionally this film, unless provided with a release liner (silicone paper, for example), leads to blocking on storage. This is one of the teachings of EP 0 768 356 A1.

The film described exhibits severe paint deformation and is very difficult to remove after use. A reason for the latter phenomenon is that the EVAc described in the examples, with 33% (w/w) vinyl acetate, has sealing properties (it is typically used for sealing applications). From 40% (w/w) vinyl acetate on, the crystalline fraction is small enough for this defect not to occur.

The adhesive sheet with EVAc adhesive that is set out in DE 195 32 220 A1 is significantly superior in adhesion to the products described. With the exception of one-component PU systems there is no effect on the finishes that are to be protected. During removal after use, however, this adhesive sheet has a high bond strength, and so cannot be removed without tearing. This increase in bond strength when the adhesive assembly is stored, which the skilled person calls peel increase, is caused by interactions of the adhesive, more particularly polar forces, with the paint. On the other hand, polar comonomers such as acrylate or vinyl acetate give rise to the desired high initial adhesion.

EP 1 190 008 A1 describes an adhesive sheet which possesses an initial bond strength sufficiently high that there is no detachment when bonding under stress (applying the adhesive sheet to curved surfaces) and yet which after prolonged storage (up to one year under weathering) can easily be removed again. At the same time there is no contraction, and the protective film can be detached without tearing and without sealing. Additionally there is no need for a release liner for storage, although when EVM adhesives with high bond strength are used, in conjunction with storage for a number of months, it is possible for high unwind forces to occur.

At the same time it is said in EP 1 190 008 A1 that the use of a polyethylene film as backing material in the surface protection film is likewise not possible on account of the deficient temperature stability.

The use of a polyethylene release film for acrylate adhesives and rubber adhesives is described by GB 676,559 A. The use of a release sheet is undesirable, however, on economic grounds for a film which is applied extensively.

Moreover, EVM adhesives have properties in respect of bond strength and change in bond strength on storage that differ from those of acrylate adhesives and rubber adhesives. For instance, the use of polyethylenes with densities of not more than 0.90 g/cm³ as release film for acrylates is described in EP 0 742 814 A1. Release films of this kind are not suitable for EVM adhesives.

It is an object of the invention, therefore, to provide a self-adhesive protective film which can still be unwound easily after prolonged storage in roll form (up to two years) and which on application possesses a sufficiently high initial tack that no detachment occurs on bonding under stress (application of the adhesive sheet to curved surfaces). At the same time there should be no contraction and the protective film should be able to be detached without tearing. Also there should be no need for a release liner for storage.

### SUMMARY OF THE INVENTION

This object is achieved by means of a self-adhesive protective film as specified in the main claim. The dependent claims provide advantageous developments of the protective film, and uses thereof. Furthermore, the invention relates to processes for their production.

The subject-matter of the invention relates accordingly to a self-adhesive protective film composed of a backing to one side of which an adhesive is applied, wherein the backing has at least two layers: a first layer, facing the adhesive, comprising an unoriented film which comprises at least one propylene block copolymer with an amount of 10% to 95% (w/w), and a second layer, facing away from the adhesive, comprising a film which contains at least 75% (w/w), preferably at least 80% (w/w), of a low-density polyethylene (PE-LD).

The first layer, the layer facing the adhesive, is known from EP 1 190 008 A1.

### BRIEF DESCRIPTION OF THE DRAWING

FIG. 1 is a graphical representation of the release force of EVAc adhesive on different polymers.

### DETAILED DESCRIPTION

In a first advantageous embodiment of the invention the low-density polyethylene (PE-LD) possesses a density of between 0.915 g/cm³ and 0.935 g/cm³, preferably between 0.915 g/cm³ and 0.930 g/cm³, and/or a melting point of between 102° C. and 120° C.

With further preference the second layer has a thickness of not more than 15 μm, preferably not more than 10 μm.

The PE-LD, moreover, is branched.

The second layer of low-density polyethylene, that facing away from the adhesive, preferably forms the outer layer of the backing. This outer layer forms the side of the backing that is not provided with adhesion promoter or with an adhesive.

The polypropylene block copolymers used (also called impact resistant polypropylene) are described in the literature in Encycl. Polym. Sci. Technol. 13, 479 ff (1988) and in Ullmann's Encyclopedia of Industrial Chemistry A21, 529 ff (1992). Examples of trade names are Propathene GSF 113 (ICI), 411 GA 05 (Amoco), PMA 6100 (Montell), Stamylan P (DSM), BD 801 F (Borealis), Daplen FFC1012 (PC), Novolen 2309 L.

Block copolymers of this kind differ from one another substantially in their melt index (=MFI=MFR) and in their comonomer content. The melt index has a divergent influence on the strength of the film and the fluidity of the melt. For the production of the first film, a melt index of 0.8 to 15 g/10 min (ISO 1133 (A/4) at 230° C. and 2.16 kg) is advantageous, in order to achieve the requirements for toughness and tensile strength on the one hand and for processing properties (production speed and uniformity of thickness in the case of coextruded films) on the other. The preferred range is between 4 and 10 g/10 min.

Where backing and adhesive are joined to one another by coextrusion, the selection of the melt index of the polypropylene block copolymer and of the other thermoplastic ingredients of the film formula is important.

The amount of comonomer in the polypropylene block copolymers determines the softness, tensile impact strength and heat stability of the protective film produced from them. The first film preferably comprises a polypropylene block copolymer with 3% to 15% (w/w) of ethylene as comonomer. The tensile impact strength to DIN 53448 ought advantageously to be at least 1000 mJ/mm² in both the longitudinal (machine) and transverse (cross) directions.

Further constituents which can be used include, for example, polyethylene (such as HDPE, LDPE, MDPE, LLDPE, VLLDPE, for example), copolymers of ethylene or of propylene with polar comonomers, polypropylene homopolymers or polypropylene random copolymers to fine-tune the properties (mechanical, thermal or other properties such as gloss, adhesion of the adhesive, extrusion characteristics, etc.). Particularly advantageous is the combination of two or more polypropylenes, more particularly of polypropylenes differing in softness and differing in melt index, such as, for example, soft block copolymer with PP homopolymer or a hard block copolymer type, since toughness, heat stability and flow characteristics can be adapted more effectively to the requirements than when a block copolymer is used alone.

For sufficient heat stability, the propylene fraction of the first layer ought to be at least 65% (w/w).

In the case of a multi-ply construction of the backing, in other words if there are further layers present between the first and the second layer and/or between the first layer and the adhesive, the first layer is the layer responsible for the strength and ought therefore to include the highest polypropylene fraction (and generally ought also to have the greatest thickness).

In a further advantageous embodiment of the invention there may be further layers additionally present in the backing or as an ingredient of the stated layers.

To improve the adhesion between backing and adhesive it is advantageous to apply an adhesion promoter layer. This layer is preferably composed of polymers and/or of components of the first layer and/or of adhesive. With particular preference the adhesion promoter comprises at least one polymer which contains at least one α-olefin and a polar comonomer. Examples thereof are ionomer, ethylene-vinyl acetate copolymer, ethylene(meth)acrylic acid copolymer or maleic anhydride-modified polyolefins.

In order to give the backing weathering stability it is advisable to add light stabilizers. Their function in the context of the use on the protective film consists primarily in preventing the embrittlement of the backing, in order to avoid problems when the adhesive surface protection tape is removed again. In the case of the two-ply or multi-ply backing, the protection relates more particularly to the first layer.

Light stabilizers of this kind are described in Gaechter and Müller, Taschenbuch der Kunststoff-Additive, Munich 1979; in Kirk-Othmer (3rd) 23, 615 to 627; in Encycl. Polym. Sci. Technol. 14, 125 to 148; and in Ullmann (4th) 8, 21; 15, 529, 676. HALS light stabilizers more particularly, such as dimethyl succinate polymer with 4-hydroxy-2,2,6,6-tetramethyl-1-piperidineethanol (CAS No. 65447-77-0), bis(2,2,6,6-tetramethyl-4-piperidinyl) sebacate (CAS No. 52829-07-9) or poly[[6-[(1,1,3,3-tetramethylbutyl)-amino]-1,3,5-triazine-2,4-diyl][[(2,2,6,6-tetramethyl-4-piperidyl)imino]hexamethylene[(2,2,6,6-tetramethyl-4-piperidyl)imino]] (CAS No. 70624-18-9), for example, are suitable for the protective film of the invention. The amount of light stabilizer ought to be at least 0.15%, preferably at least 0.30% (w/w) relative to the film.

Preferably the UV permeability of the protective film in the range from 290 to 360 nm is below 1%, preferably below 0.1%.

The use of antioxidants for the film (for example Irganox 1010 or trisnonylphenyl phosphite) is advantageous, but not absolutely necessary. Further suitable UV absorbers, light stabilizers and ageing inhibitors are set out in EP 0 763 584 A1.

An improvement in the light stability of backing film is also possible through other additions to the protective film, more particularly in the first layer of the backing. This may be done by means of UV absorbers (for example Tinuvin P, Ciba) or, primarily, by means of reflecting pigments (for example titanium dioxide).

It can be appropriate to preformulate batches of film additives such as titanium dioxide, light stabilizers, ageing inhibitors or processing aids, individually or together, preferably in polyethylene, polypropylene or polypropylene block copolymer.

Thicknesses for the backing of 20 to 80 μm (including the adhesion promoter layer, where appropriate) are preferred.

The softness of the backing plays a part in the context of the deformability during application of the protective film; the force at 10% extension should not exceed 25 N/15 mm, preferably 16 N/15 mm, in either the longitudinal or transverse directions (tensile test in accordance with DIN 53455-7-5). This is also one of the reasons why all of the films of the backing ought preferably to be unoriented.

Orientation (also called stretching or drawing) raises the force at 10% extension so greatly that the conformability is no longer a given (for comparison, typical values are 100 N/15 mm for monoaxially oriented PP block copolymer and 180 N/15 mm for biaxially oriented homopolymer).

Furthermore, the strength in the transverse direction with respect to orientation or in the third dimension (perpendicular to the film surface) is so greatly reduced that when the protective film of the invention is removed there is a danger of tearing or delamination in the third dimension (also called splitting). This applies in particular with adhesives possessing particularly good adhesion, such as, for example, the preferred ethylene-vinyl acetate copolymer adhesives.

The protective films of the invention preferably feature a contraction in the longitudinal and transverse directions of less than 3%, with particular preference less than 1%. The contraction is measured in a forced-air oven at 120° C. For this purpose the sample is placed on a heavily talced paperboard for 10 minutes.

As adhesives it is possible to use elastomers such as, for example, EPDM or EPM rubber, polyisobutylene, butyl rubber, EVM (ethylene-vinyl acetate copolymer), hydrogenated block copolymers of dienes (for example by hydrogenation of SBR, cSBR, BAN, NBR, SBS, SIS or IR; such polymers are known, for example, as SEPS and SEBS) or acrylate copolymers such as ACM. Since the protective films of the invention are to be stable with respect to ageing and weathering, unstable unsaturated elastomers such as natural rubber, SIS, SBS, SBR or NBR are less suitable. The light stabilizers specified for the films may also be employed for the adhesive. This addition enhances the ageing stability of the adhesive, especially in the case of UV exposure above 100 kLy (Kilolangleys, corresponding to kcal/cm²), but is indispensable for applications involving up to six months' outdoor weathering in the case of ethylene vinyl acetate copolymer adhesives. In the case of polyisobutylene homopolymer adhesives or butyl rubber adhesives, an addition of this kind is mandatory if adhesive residues are to be avoided under very severe UV exposure.

It can be advantageous to crosslink the adhesive. This raises the heat stability (for example, under alternating climatic conditions). Peel increase on rough or non-polar substrates such as synthetic rubber window seals is reduced as a result. In particular the crosslinking also enhances the shear strength. This is particularly important in the context of protective film application, since it presents resistance to the shrinkage of the protective film in application. For crosslinking, the typical crosslinking agents are suitable. Preference is given to the process of radiation crosslinking, more particularly with UV radiation and electron beams. In the case of UV radiation, the adhesive is irradiated from the adhesive side. The radiation dose can be reduced by using photoinitiators or by adding crosslinking promoters such as esters of allyl alcohol, of methacrylic acid or of acrylic acid to the adhesive.

Copolymers of ethylene or vinyl acetate, more particularly ethylene-vinyl acetate copolymers having a VAc fraction of at least 40% (w/w), have been found to be particularly suitable. They guarantee a high bond strength even in critical cases (adhesive-repelling paints or sharply curved bond areas), and possess high weathering stability even without the addition of light stabilizers in the adhesive. Preference is given to a VAc fraction of 55% to 70% (w/w). The combination of unoriented polypropylene block copolymer as the first layer and ethylene-vinyl acetate copolymer as the adhesive is also favourable on account of the fact that the one material exhibits little contraction and the other is very highly resistant (shear strength) to shrinkage in the bonded state. The shear strength is so good that in general it is possible to dispense with crosslinking.

In order to optimize the properties, more particularly the bonding behaviour on specific paints, the self-adhesive composition employed (adhesive) may be blended with one or more additives such as tackifiers (resins), plasticizers, fillers, pigments, UV absorbers, light stabilizers, ageing inhibitors, crosslinking agents or crosslinking promoters.

Examples of tackifiers are hydrocarbon resins (formed, for example, from unsaturated C₅ or C₇ monomers), terpene phenolic resins, terpene resins made from raw materials such as α- or β-pinene, aromatic resins such as coumarone-indene resins or resins of styrene or α-methylstyrene, such as rosin and its derivatives, such as disproportionated, dimerized or esterified resins, it being possible to use glycols, glycerol or pentaerythritol, and also others as listed in Ullmann's Encyclopädie der technischen Chemie, volume 12, pages 525 to 555, (4th ed.), Weinheim. Particularly suitable are resins stable to ageing, without an olefinic double bond, such as hydrogenated resins, for example.

Examples of suitable fillers and pigments are carbon black, titanium dioxide, calcium carbonate, zinc carbonate, zinc oxide, silicates or silica.

Suitable UV absorbers, light stabilizers and ageing inhibitors for the adhesives are the same as those listed for the stabilization of the films.

Examples of suitable plasticizers are aliphatic, cycloaliphatic and aromatic mineral oils, diesters or polyesters of phthalic acid, trimellitic acid or adipic acid, liquid rubbers (for example nitrile rubbers or polyisoprene rubbers), liquid polymers of butene and/or isobutene, acrylic esters, polyvinyl ethers, liquid resins and plasticizer resins based on the raw materials for tackifier resins, wool wax and other waxes, or liquid silicones.

Examples of crosslinking agents include phenolic resins or halogenated phenolic resins, melamine resins and formaldehyde resins. Suitable crosslinking promoters are, for example, maleimides, allyl esters such as triallyl cyanurate, and polyfunctional esters of acrylic and methacrylic acid.

With certain paint systems it is advantageous to add ingredients of the paints to the adhesive in order to reduce the migration of paint ingredients (for example fatty acid esters of glycerol, silicones, or other plasticizers) from the paint into the adhesive. Paint ingredients of this kind are described in more detail in EP 0 763 584 A1 and U.S. Pat. No. 5,612,135 A1.

It is advantageous, furthermore, for physical recycling and heat energy recovery if the adhesive, more particularly the entire protective film, is halogen-free.

With particular advantage the protective film of the invention can be produced by coextrusion, with all of the layers (backing, adhesion promoter, adhesive) being coextruded simultaneously. This represents the best solution from a technical standpoint.

The backing alone may likewise be produced by coextruding the first layer and second layer and also the further layers, where present.

Films of this kind can be fabricated on blowing lines or, preferably, casting lines (T-die technology), the films not being monoaxially or biaxially oriented by drawing (orientation) with drawing rolls or drawing frames. When films of this kind are blown, the orientation should be minimized via take-off speed, blow-up ratio and temperature profile.

Coextrusion is also a suitable means of applying the adhesion-promoting layer during the preparation of the backing.

The adhesion promoter can be applied by coextrusion with the backing, by coextrusion with backing and adhesive, or by coating on the backing.

In one advantageous embodiment the adhesion promoter is applied simultaneously during the extrusion of the backing, so that the resulting coextruded film need only then be coated with the adhesive.

Virtually all attempts to produce adhesive, adhesion promoter and the first layer/film (comprising the block copolymer) by coextrusion in one working step have failed to date, since at a width of more than 1 m it was impossible to achieve uniform layer thickness distribution. The repetition of examples known from the literature for the production of protective films of the general kind by coextrusion shows that it was not possible to achieve application-compatible layer thickness distribution if the width of the line is more than 1 m. This is particularly true when using raw materials for strongly adhering adhesives, i.e. not only slightly tacky, partially crystalline copolymers of the kind typically used for sealing layers.

It was very surprising, therefore, that ethylene-vinyl acetate copolymers with at least 40% (w/w) of vinyl acetate could be coextruded with block copolymers as described in the example. The layer thickness distribution is so good that, with a running length of 1000 m and a width of 1.5 m, uniformly wound rolls were formed and the bond strength to steel (AFERA 4001) across the width is situated within a tolerance range of ±20%. In order to achieve this outcome, the melt indices of the raw materials of the layers and the temperatures of the melt flows have to be harmonized with one another.

The most favourable ranges are the following:

The melt indices of the films (including sublayers such as primer) are in the range from 0.3 to 10 g/10 min at 230° C. and 2.16 kg, and for the adhesive are in the range from 0.5 to 10 g/10 min at 190° C. and 2.16 kg. The density of the PE-LD used is in the range from 0.915 to 0.930 g/cm³. The temperature of the adhesive melt is below that of the film (measured at the point where the melt flows unite).

The advantages of the subject-matter of the invention make it especially suitable for application on painted vehicles such as cars. In this context a bond strength of at least 0.7 N/cm even in the freshly bonded state is desirable (AFERA method 4001, corresponding to DIN EN 1939) in order that the film cannot become detached at bond edges after application as a result of the stresses (particularly in the case of uneven bonding) or cannot become detached entirely as a result of the slipstream during transit or driving of the car. Since the bond strength to paints depends on the particular paint formulation, the bond strength of the protective film may be characterized more effectively by means of the bond strength to steel (AFERA). In the freshly bonded state this strength ought as far as possible to be between 0.2 and 3.8 N/cm, preferably between 0.7 and 1.7 N/cm.

Furthermore, the protective film of the invention is particularly suitable for assembly protection or transit protection of the fresh finish of cars or as protection for freshly painted steel panels in machining and transit. The protective film can be bonded just half an hour after the painted surfaces have passed through the oven, without any disadvantages whatsoever, despite the fact that at this point in time the paint has not yet fully cured. The protective film also displays outstanding properties when used as an edge-securing tape for the additional fastening of other kinds of extensive self-adhesive cover films with low bond strength.

A further feature of the protective film of the invention is that it can be applied in a large width over the bonnet, roof and boot of cars and that, owing to its deformability, it conforms very well to planar and even gently curved shaped areas. It is therefore possible to protect the horizontal areas which are most at risk from soiling. However, even narrow areas such as, for example, the projection of the door below the windows, or bumpers, can easily be covered. Protection of the vertical areas on the vehicle is particularly appropriate during its assembly. In spite of the effective extensibility, the defect of shrinkage of conventional readily deformable protective polyethylene films is not in evidence.

The protective film is resistant to sunlight, moisture, heat and cold, with weathering stability of at least one year. In particular the addition of pigments such as titanium dioxide and of light stabilizers leads to an improvement in the UV stability of the protective film. Even very high sun levels, such as those encountered in Florida, for example, do not cause the protective film to fail or detach. The extremely low UV permeability of the protective film prevents the adhesive being broken down by sun exposure.

Furthermore, the strength of the protective film in comparison to preservation with wax ensures impeccable protection against soiling such as bird droppings and against damage to the vehicle as a whole by minor mechanical events. Despite the requisite strength of adhesion, the protective film can be removed, after service, without residue and without tearing of the backing film. It is possible to recycle the protective film or recover energy from it, more particularly since it is halogen-free.

Through the use of the polypropylene block copolymer in the first layer, the protective film does not tear when it is removed, even when the adhesive has good adhesion.

In the course of a test of surface protection tapes following UV weathering it was found that, in the case of backing film made from standard polypropylene (polypropylene homopolymer), standard polyethylene (HDPE) or a 1:1 blend thereof, embrittlement occurred very rapidly; in the case of LDPE or random polypropylene copolymer (with 5% ethylene) the conditions are more favourable, while the best results are achieved with polypropylene block copolymer containing 3% to 15% (w/w) ethylene. The advantages of using polypropylene block copolymer for the first layer therefore stand out particularly well in the case of removal after weathering, which is highly relevant to practical use. With the present invention's preferred combination of polypropylene block copolymer for the first layer and strongly adhering ethylene-vinyl acetate copolymer for the adhesive, it is possible to attain the important properties of high adhesion and yet good redetachability of the protective film in an impressive way without contradiction.

A further advantage has emerged as being the resistance of the protective film of the invention to shrinkage under hot conditions. This is important so that no greasy traces of the adhesive are formed at the edges of the surface covered with the protective film. It is also advantageous for the passage of the protective film through an oven for the purpose of drying the adhesive. Protective films comprising polyethylene as their main ingredient lack sufficient heat stability, even though the conformability (extensibility) is particularly favourable for automotive application.

The use of polyethylene or of polypropylene random copolymers as a major ingredient of the film of surface protection tapes is customary on account of the fact that the conformability (see above under softness/deformability) is favourable. Additionally, the toughness is better than with polypropylene (homopolymer), which has good heat resistance but is less brittle. The same applies to protective films for covering cars. Protective films of this kind have the disadvantage, however, that the heat stability is only moderate.

The use of polypropylene block copolymers as a major ingredient in the first film uniquely resolves the conflict between adequate softness on the one hand and heat stability on the other. The same applies to the contradictory requirement for high toughness in tandem with heat stability.

Strongly adhering ethylene-vinyl acetate copolymer adhesive leads to relatively difficult unwinding after storage of the rolls of the protective film unless a release agent is used as a substantial film ingredient. Difficulty in unwinding leads not only to overexertion on the part of the operatives using the film, but also to an irreversible distortion of the protective film at those points grasped by the operative (or by a gripper device) in order to unwind the roll.

Unforeseeably and surprisingly for the person skilled in the art, a protective film having a second, outer layer of PE-LD and a bond strength of the ethylene-vinyl acetate adhesive on the first layer to steel of between 0.2 and 3.8 N/cm shows the desired combination of properties, particularly when ethylene-vinyl acetate copolymer with at least 40% (w/w) vinyl acetate is used:
low unwind forces both before and, in particular, after storage
effective anchoring of the pure PE-LD layer on the first layer

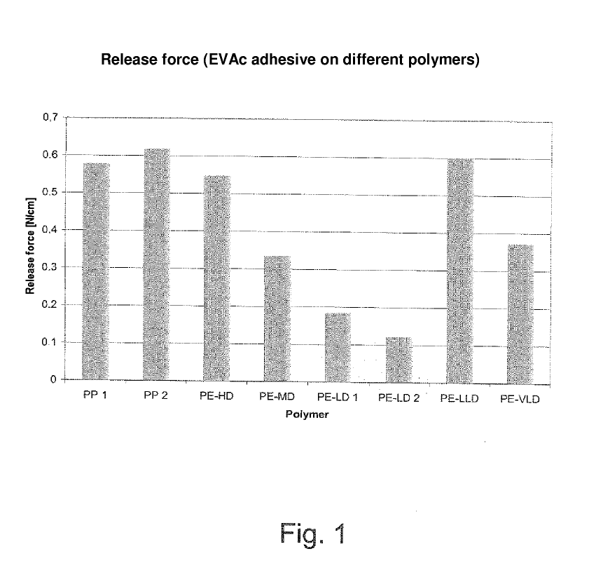

Unlike many other polyethylenes (for example PE-HD, PE-MD, PE-LLD) and polypropylene, the bond strengths of an adhesive based on ethylene-vinyl acetate copolymer to a layer of PE-LD are much lower and also remain so on storage (compare FIG. 1). In this case, with an outer layer of PE-LD present, additional coating with a release varnish, as must be carried out for many adhesive tapes, is unnecessary. In spite of the incompatibility between polypropylene and polyethylene, of which a person skilled in the art is aware, the anchoring of the PE-LD layer to the layer with a polypropylene block copolymer component is sufficiently high for the application.

The EVAc self-adhesive compositions that are used with preference possess, on the one hand, good strength of adhesion to a variety of paints that are customary in the automotive industry, and retain this property even under the effect of moisture or humid conditions, so that the protective film does not detach from the vehicle even under wind exposure or under tension caused by bonding to curved surfaces. Moreover, this self-adhesive composition possesses a sufficient bond strength within the first few minutes after application, so that after just half an hour, for example, the protective film can be exposed to a severe slipstream load (up to 160 km/h), but on the other hand may also be removed without tearing following prolonged use.

The peel force (bond strength) of the protective film of the invention with EVAc self-adhesive compositions from 2 K [2-component] PU paints is generally more than 0.7 in the fresh state and less than 4 N/cm following storage under alternating climatic conditions (in analogy to AFERA method 4001). Even exposure of the protective film to UV light, using for example Xenotest 1200 at 55° C. for 3000 hours, does not result in any deficiencies in the properties of the protective film. There is no embrittlement of the film and there are no residues of composition on removal.

### Test Methods

The measurements are made, unless indicated otherwise, under test conditions of 23±1° C. and 50±5% relative humidity.

The tension/extension behaviour of the protective film is determined on test strips 15 mm wide and 150 cm long, clamped-in length 100 mm, in accordance with DIN EN ISO 527-3/2/300, at a test speed of 300 mm/min.

The instantaneous bond strengths are determined at a peel angle of 180° in a method based on AFERA 4001 using test strips 20 mm wide. In this case, PVC plaques according to the AFERA standard are used as the test substrate, and a strip of the adhesive tape under test is applied to these plaques. A second strip is applied to the rear of the first strip, and its bond strength to the rear of the first is tested in accordance with AFERA 4001.

The release force is determined on a bond of two test strips each 20 mm wide. The open side of the adhesive of the bond is lined with a PVC strip which is likewise 20 mm wide and 30 μm thick. Prior to measurement, the sample is stored at 40° C. for 7 days under a weight load on the bond of 2 N/cm². Following storage, the test strips are cut to a length of 220 mm and stored under the test conditions for two hours. For the measurement, the upper test strip of the bond is clamped into the upper jaw of a tensile testing machine of the kind used in AFERA 4001. The bottom test strip and also the PVC strip are clamped into the lower jaw. The spacing of the jaws in this case is 50 mm. The measurement takes place at a speed of 300 mm/min, the speed at which the jaws are moved apart. The average value, determined over a distance of 100 mm, for the force required to release the bond corresponds to the release force.

The thickness is determined in accordance with DIN 53370, with the gauge being planar (not curved). In the case of textured films, however, the thickness in question is the thickness prior to embossing. This can also be done subsequently via the basis weight (determined in accordance with DIN 53352) with conversion using the density. The depth of embossing is the difference between the thicknesses with and without embossing.

The examples which follow are intended to illustrate the invention without restricting its scope.

### EXAMPLES

### Comparative Example 1

A film was manufactured by flat film extrusion in a width of 1450 mm. It was composed of a first layer 50 μm thick and an adhesion promoter layer 10 μm thick on the free side of the first layer.

The first layer was composed of
91.3% (w/w) of Novolen 2309 L block copolymer (BASF, melt index 6 g/10 min at 230° C. and 2.16 kg, ethylene content about 6.5% (w/w)),
8.4% (w/w) of titanium dioxide and
0.3% (w/w) of the HALS stabilizer Tinuvin 770.

The adhesion promoter layer was composed of 50% (w/w) of Novolen 2309 L and 50% (w/w) of an EVAc copolymer, Escorene Ultra UL 00728 (Exxon). Prior to extrusion, the raw materials were premixed using a concrete mixer.

The adhesive prepared was a 10% strength solution of the following base materials in toluene:
65% (w/w) of a copolymer of 70% (w/w) vinyl acetate and 30% (w/w) ethylene, having a Mooney viscosity ML (1+4) at 100° C. (DIN 53523) without pretreatment of 28
30% (w/w) of a copolymer of 45% (w/w) vinyl acetate and 55% (w/w) ethylene, having a Mooney viscosity ML (1+4) at 100° C. (DIN 53523) without pretreatment of 18
4.8% (w/w) of a hydrogenated glycerol ester of rosin
0.2% (w/w) of Irganox 1010 (antioxidant).

The adhesive solution was applied to the film using a coating bar and was dried in a tunnel at 80° C. for four minutes. The protective film obtained was edged and wound into rolls 200 m long and 1400 mm wide. The application of adhesive amounted to 12 μm.

The self-adhesive film produced in this way was readily unwindable, without creases, and could be applied flawlessly when used to protect cars.

### Comparative Example 2

A film was manufactured by flat film extrusion in a width of 1450 mm. It was composed of a first layer 50 μm thick, an outer layer 10 μm thick and an adhesion promoter layer 10 μm thick on the free side of the first layer.

The composition of the first layer was the same as in Comparative Example 1.

The outer layer was composed of 100% (w/w) of Lupolen 3721 C (Basell, PE-MD, d=0.937 g/cm³).

Adhesion promoter layer and adhesive were the same as in Comparative Example 1.

The adhesive solution was applied to the film using a coating bar and was dried in a tunnel at 80° C. for four minutes. The protective film obtained was edged and wound into rolls 200 m long and 1400 mm wide. The application of adhesive amounted to 12 μm.

The self-adhesive film produced in this way was readily unwindable, without creases, and could be applied flawlessly when used to protect cars.

### Comparative Example 3

A film was manufactured by flat film extrusion in a width of 1450 mm. It was composed of a first layer 50 μm thick, an outer layer 10 μm thick and an adhesion promoter layer 10 μm thick on the free side of the first layer.

The composition of the first layer was the same as in Comparative Example 1.

The outer layer was composed of 100% (w/w) of Polyethylene LL 1030XV (ExxonMobil Chemical, PE-LLD, d=0.918 g/cm³).

Adhesion promoter layer and adhesive were the same as in Comparative Example 1.

The adhesive solution was applied to the film using a coating bar and was dried in a tunnel at 80° C. for four minutes. The protective film obtained was edged and wound into rolls 200 m long and 1400 mm wide. The application of adhesive amounted to 20 μm.

The self-adhesive film produced in this way was readily unwindable, without creases, and could be applied flawlessly when used to protect cars.

### Comparative Example 4

A film was manufactured by flat film extrusion in a width of 1450 mm. It was composed of a first layer 50 μm thick, a second layer (outer layer) 10 μm thick and an adhesion promoter layer 10 μm thick on the free side of the first layer.

The composition of the first layer was the same as in Comparative Example 1.

The outer layer was composed of PE-LD and PP copolymer (70% (w/w) ExxonMobil Chemical LD252, density=0.923 g/cm³, 30% (w/w) Daplen FFC 2012 block copolymer).

Adhesion promoter layer and adhesive were the same as in Comparative Example 1.

The adhesive solution was applied to the film using a coating bar and was dried in a tunnel at 80° C. for four minutes. The protective film obtained was edged and wound into rolls 200 m long and 1400 mm wide. The application of adhesive amounted to 12 μm.

The self-adhesive film produced in this way was readily unwindable, without creases, and could be applied flawlessly when used to protect cars.

### Example 1

A film was manufactured by flat film extrusion in a width of 1450 mm. It was composed of a first layer 50 μm thick, an outer layer 10 μm thick and an adhesion promoter layer 10 μm thick on the free side of the first layer.

The composition of the first layer was the same as in Comparative Example 1.

The outer layer was composed of 100% (w/w) of Polyethylene LD252 (ExxonMobil Chemical, PE-LD, d=0.923 g/cm³).

Adhesion promoter layer and adhesive were the same as in Comparative Example 1.

The adhesive solution was applied to the film using a coating bar and was dried in a tunnel at 80° C. for four minutes. The protective film obtained was edged and wound into rolls 200 m long and 1400 mm wide. The application of adhesive amounted to 12 μm.

The self-adhesive film produced in this way was readily unwindable, without creases, and could be applied flawlessly when used to protect cars.

### Example 2

The protective film was produced by coextruding four layers, including adhesive.

Raw materials:
First layer 50 μm:
60% (w/w) Daplen FFC 2012 block copolymer (PCD, melt index 5 g/10 min at 230° C. and 2.16 kg, ethylene content about 12% (w/w)),
25% (w/w) Daplen KF 201 homopolymer (PCD, melt index 8 g/10 min at 230° C. and 2.16 kg),
6.3% (w/w) Lupolen 1840H (LDPE, Elenac GmbH, melt index 1.5 g/10 min at 190° C. and 2.16 kg, density 0.919 g/cm³).
8.4% (w/w) Titanium dioxide and
0.3% (w/w) Tinuvin 770.
Second layer 10 μm:
100% Polyethylene LD165BW1 (ExxonMobil Chemical PE-LD, d=0.922 g/cm³).
Adhesion promoter layer 10 μm:
as Comparative Example 1
Adhesive layer 12 μm:
copolymer of 59.5% (w/w) vinyl acetate and 39.5% (w/w) ethylene having a melt index of 3 g/10 min at 190° C. and 2.16 kg. Prior to extrusion, the raw adhesive material was processed into granular particles approximately 5 mm in size, with the addition of about 1% (w/w) of silica as a powdering agent.

The roll of protective film produced in this way was 1.5 m wide and 1000 m long, of excellent winding quality. The roll could be unwound easily, without creases, and was applied flawlessly when used to protect cars. Following use, this self-adhesive film could be peeled off again without deficiencies for up to a year of bonding under outdoor weathering conditions.

### Example 3

A film was manufactured by flat film extrusion in a width of 1450 mm. It was composed of a first layer 50 μm thick, an outer layer 10 μm thick and an adhesion promoter layer 10 μm thick on the free side of the first layer.

The composition of the first layer was the same as in Comparative Example 1.

The outer layer was composed of PE-LD and PP copolymer (85% (w/w) ExxonMobil Chemical LD252, density=0.923 g/cm³, 15% (w/w) Daplen FFC 2012 block copolymer).

Adhesion promoter layer and adhesive were the same as in Comparative Example 1.

The adhesive solution was applied to the film using a coating bar and was dried in a tunnel at 80° C. for four minutes. The protective film obtained was edged and wound into rolls 200 m long and 1400 mm wide. The application of adhesive amounted to 12 μm.

The self-adhesive film produced in this way was readily unwindable, without creases, and could be applied flawlessly when used to protect cars.

### Comparison of Properties

| | Instantaneous bond | |
|---|---|---|
| | strength [N/cm] | Release force [N/cm] |
| Comparative Example 1 | 0.22 | 0.55 |
| Comparative Example 2 | 0.11 | 0.33 |
| Comparative Example 3 | 0.17 | 0.60 |
| Comparative Example 4 | not measured | 0.54 |
| Example 1 | 0.06 | 0.18 |
| Example 2 | 0.13 | 0.12 |
| Example 3 | not measured | 0.33 |

A comparison of the bond strengths from Examples 1 and 2 with those of the comparative examples makes it clear that the bond strengths of the ethylene-vinyl acetate adhesive on the films with PE-LD outer layer were well below those of the other outer layers, particularly in the case of the release force. Whereas the instantaneous bond strengths of the examples are often still in the same order of magnitude as the comparative examples, the release forces after prolonged storage at elevated temperature in no case attain the same level as the comparative examples when an outer layer of PE-LD is used. The reason for these differences between instantaneous bond strength and release force lie in a change to the bond strength of the ethylene-vinyl acetate adhesive on different substrates when the adhesive assembly is stored. Whereas, in the course of storage, there is usually an increase in the bond strength, this does not occur, or occurs only to a slight extent, for the bond on PE-LD. Accordingly this substrate is particularly suitable for achieving a low unwind force even after storage. From Example 3 and Comparative Example 4 it is apparent that a blend of a PE-LD with PP copolymer still gives low release forces for a PE-LD fraction of 85%, whereas a PE-LD fraction of only 70% no longer displays a sufficient effect.

1. Self-adhesive protective film having a backing to one side of which an adhesive is applied, wherein the backing has at least two layers: a first layer, facing the adhesive, comprising an unoriented film which comprises at least one propylene block copolymer with an amount of 10% to 95% (w/w), and a second layer, facing away from the adhesive, comprising a film which contains at least 75% (w/w), of a low-density polyethylene.

2. Self-adhesive protective film according to claim 1, wherein the low-density polyethylene possesses a density of between 0.915 g/cm³ and 0.935 g/cm³.

3. Self-adhesive protective film according to claim 1, wherein the second layer has a thickness of not more than 15 μm.

4. Self-adhesive protective film according to claim 1, wherein the melt index of the polypropylene block copolymer is between 0.8 and 15 g/10 min at 230° C. and 2.16 kg.

5. Self-adhesive protective film according to claim 1, wherein the ethylene content of the polypropylene block copolymer is between 3% and 15% (w/w).

6. Self-adhesive protective film according to claim 1, wherein the fraction of propylene block copolymer in the first layer is at least 65% (w/w).

7. Self-adhesive protective film according to claim 1, comprising an adhesion promoter between the backing layer and the adhesive.

8. Self-adhesive protective film according to claim 7, wherein the adhesion promoter comprises at least one polymer which contains at least one α-olefin and a polar comonomer.

9. Self-adhesive protective film according to claim 1, wherein the layer of adhesive is composed of at least one copolymer of ethylene and vinyl acetate, the amount of vinyl acetate in the layer of adhesive being at least 40% (w/w).

10. Self-adhesive protective film according to claim 1, having a bond strength to steel of between 0.2 and 3.8 N/cm.

11. Self-adhesive protective film according to claim 1, wherein the thickness of the backing is between 20 and 80 μm.

12. Self-adhesive protective film according to claim 1, wherein said first layer of said backing comprises at least one light stabilizer in an amount of at least 0.15% (w/w).

13. Self-adhesive protective film according to claim 1, wherein the backing layer is produced by coextruding at least two layers, one of which is a layer turned towards the adhesive and the other of which is an outer layer, and the outer layer comprises the low-density polyethylene.

14. Self-adhesive protective film according to claim 13, wherein the backing layer is coextruded together with the adhesion promoter layer.

15. Process for producing the self-adhesive protective film of claim 1, wherein the layers of the backing, and optionally the adhesion promoter layer and the adhesive, are coextruded simultaneously.

16. Process for producing a self-adhesive protective film of claim 1, wherein the layers of the backing and, optionally, the adhesion promoter layer are coextruded simultaneously, an adhesive being subsequently applied to the adhesion promoter layer.

17. Method for protecting painted surfaces on vehicles, which comprises applying the self-adhesive protective film of claim 1 to said painted surfaces before the assembly of the vehicle.

18. Self-adhesive protective film according to claim 9, wherein the amount of vinyl acetate in the layer of adhesive is 55% to 70% (w/w).

19. Method for the assembly protection or transit protection of the fresh finish on the surfaces of vehicles, or protection of the surfaces of freshly painted steel panels in machining and transit. which comprises applying the self-adhesive protective film of claim 1 to said surfaces.
